(19) United States
(12) Patent Application Publication
(10) Pub. No.: US 2015/0002880 A1
(43) Pub. Date: Jan. 1, 2015

(54) PRINTING APPARATUS

(71) Applicant: RISO KAGAKU CORPORATION, Tokyo (JP)

(72) Inventor: Junichi Hakamada, Ibaraki (JP)

(21) Appl. No.: 14/309,343

(22) Filed: Jun. 19, 2014

(30) Foreign Application Priority Data
Jun. 28, 2013 (JP) 2013-137248

(51) Int. Cl. G06K 15/02

(52) U.S. Cl. CPC G06K 15/1807; G06K 15/1867
USPC 358/1.14; 358/1.15

(57) ABSTRACT

A two dimensional code image generation unit that generates, on the basis of job data, an image of a two dimensional code by utilizing a margin area, which is an area other than an area on which the image of the two dimensional code has been printed in a printable area in printing of the image of the two dimensional code, and a printer unit that prints, on a print sheet, the image of the two dimensional code generated by the two dimensional code image generation unit.

### CROSS-REFERENCE TO RELATED APPLICATIONS

This application is based upon and claims the benefit of priority of the prior Japanese Patent Application No. 2013-137248, filed on Jun. 28, 2013, the entire contents of which are incorporated herein by reference.

### FIELD

The present invention relates to a printing apparatus.

### BACKGROUND

In many environments such as offices in recent years, an information terminal device and a multifunction printer are connected via a network and users of the information terminal device have been allowed to make the multifunction printer perform a printing process of desired data by giving printing instruction via the information terminal device.

However, it is necessary to store data to be printed in for example a USB (Universal Serial Bus) memory and insert the USB memory to a slot of a multifunction printer in order to perform a printing process in an environment in which the multifunction printer is not connected to a network because of for example security problems or the like.

Because leaving behind of a USB memory or the like can happen, security problems are not solved even when a USB memory is used. Also, it is necessary to prepare as many USB memories as there are people who use a multifunction printer, which is not desirable in view of cost.

As an example of a technique that can be applied to the above problems, a technique is known that represents binary data as image data (two dimensional code) that is a result of two dimensionally arranging block-shaped patterns (see Patent Document 1 for example).

When a technique of two dimensional code is applied to the above problems, i.e., when data to be printed is encoded into a two dimensional code, the code is printed by a printer, the printed code is read by the scanner of a multifunction printer and the printing target data is decoded so as to perform a printing process, the problems of security and cost can be solved.
Patent Document 1: Japanese Laid-open Patent Publication No. 7-254037

### SUMMARY

When printing target data has been converted into a two dimensional code and has been printed, the decoding into a print image, which is an image before the data has been converted into the two dimensional code, sometimes fails. It is because the reading resolution of the scanner or the like of the printing apparatus is low, an error correction code added to the two dimensional code cannot be read accurately or for other reasons in the reading of the printed two dimensional code.

In view of the above problem, it is an object of the present invention to provide an printing apparatus that prevents the occurrence of a margin area in a print sheet when printing target data is converted into a two dimensional code and is printed.

A printing apparatus according to an aspect is a printing apparatus that generates an image of a two dimensional code and prints the image on the basis of job data in order to cause a different printing apparatus including a reading unit that reads the image of the two dimensional code to execute a printing process, the printing apparatus including a processor which performs a process including setting a dot size for printing the image of the two dimensional code, changing the dot size to a dot size that can be read at least by the reading unit, by utilizing a margin area, which is an area other than an area on which the image of the two dimensional code has been printed in a printable area in the printing of the image of the two dimensional code, generating, on the basis of the job data, the image of the two dimensional code based on the dot size after being changed, and a printer unit that prints, on a print sheet, the image of the two dimensional code generated.

According to the printing apparatus of an aspect, the dot size of a two dimensional code is changed (increased) so that a margin area is eliminated. This configuration makes it possible to utilize the printing surface of a print sheet efficiently and to suppress the occurrence of an reading error by utilizing a margin area so as to increase the dot size of the two dimensional code when there is a margin area.

A printing apparatus according to another aspect is a print ing apparatus that generates an image of a two dimensional code and prints the image on the basis of job data in order to cause a different printing apparatus including a reading unit that reads the image of the two dimensional code to execute a printing process, the printing apparatus including a processor which performs a process including setting a size of a dot for printing the image of the two dimensional code, changing a correction rate of an error correction code in the two dimensional code, by utilizing a margin area, which is an area other than an area on which the image of the two dimensional code has been printed in a printable area in the printing of the image of the two dimensional code, generating, on the basis of the job data, the image of the two dimensional code based on the correction rate after being changed, and a printer unit that prints, on a print sheet, the image of the two dimensional code generated.

According to the printing apparatus of another aspect, the correction rate of an error correction code is changed (increased) so that a margin area is eliminated. This configuration makes it possible to utilize the printing surface of a print sheet effectively and to improve the error correction ability so as to suppress the occurrence of a reading error by utilizing a margin area so as to increase the correction rate of an error correction code when there is a margin area.

### BRIEF DESCRIPTION OF DRAWINGS

FIG. 1 shows a configuration example of a printing system according to embodiment 1.

FIG. 2 is a functional block diagram showing a configuration example of a printing apparatus, which is a constituent of the printing system according to embodiment 1.

FIG. 3 shows an example of a sheet property information table according to embodiment 1.

FIG. 4 shows an example of a multifunction printer information management table according to embodiment 1.

FIG. 5 shows an example of a two dimensional code printed on a printing sheet according to embodiment 1.

FIG. 6 shows an example of a graph of a function representing the relationship between an error occurrence rate and a dot size adjustment value according to embodiment 1.

FIG. 7 is a functional block diagram showing a configuration example of an information terminal device, which is a constituent of the printing system according to embodiment 1.

FIG. 8 is a functional block diagram showing a configuration example of a multifunction printer, which is a constituent of the printing system according to embodiment 1.

FIG. 9 shows an example of a flowchart for explaining a flow of a two dimensional code image generation process according to embodiment 1.

FIG. 10 shows an example of a flowchart for explaining a flow of a size reduction process according to embodiment 1.

FIG. 11 is a functional block diagram showing a configuration example of a printing apparatus, which is a constituent of the printing system according to embodiment 2.

FIG. 12 shows an example of a graph of a function representing the relationship between an error occurrence rate and a correction rate adjustment value according to embodiment 2.

FIG. 13 shows an example of a flowchart for explaining a flow of a two dimensional code image generation process according to embodiment 2.

FIG. 14 shows an example of a flowchart for explaining a flow of a size reduction process according to embodiment 2.

FIG. 15 is a functional block diagram showing a configuration example of a printing apparatus, which is a constituent of the printing system according to embodiment 3.

FIG. 16 is a functional block diagram showing a configuration example of an information terminal device, which is a constituent of the printing system according to embodiment 3.

FIG. 17 shows an example of a setting changing window according to embodiment 3.

FIG. 18 shows a part of an example of a flowchart for explaining a flow of a two dimensional code image generation process according to embodiment 3.

FIG. 19 shows another part of an example of a flowchart for explaining a flow of a two dimensional code image generation process according to embodiment 3.

FIG. 20 shows an example of a flowchart for explaining a flow of a size reduction process according to embodiment 3.

FIG. 21 shows an example of a flowchart for explaining a flow of a printing setting changing process according to embodiment 3.

### DESCRIPTION OF EMBODIMENTS

Hereinbelow, detailed explanations will be given for the embodiments of the present invention by referring to the drawings.

### Embodiment 1

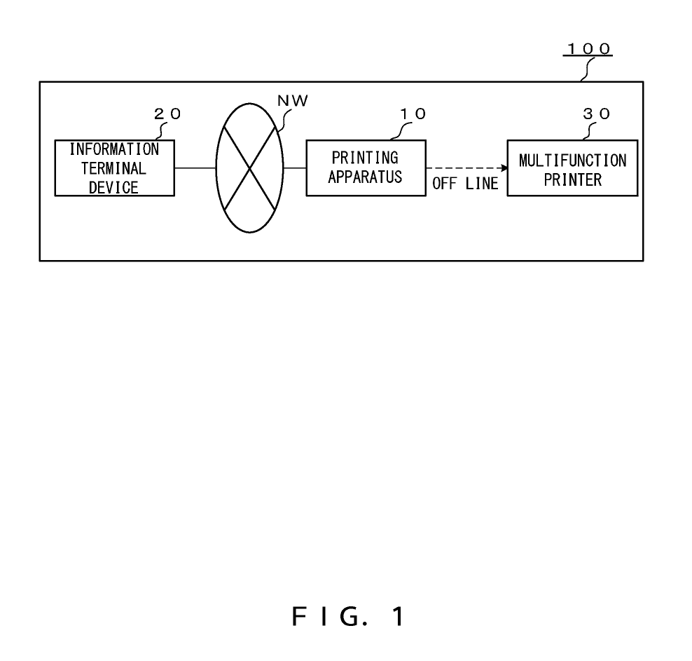

FIG. 1 shows a configuration example of a printing system 100 according to present embodiment 1. The printing system 100 includes, as shown in FIG. 1, a printing apparatus 10, which is an image generation device, one or a plurality of information terminal devices 20 and one or a plurality of multifunction printers 30, and the printing apparatus 10 and the information terminal device 20 are connected via network NW in such a manner that they can communicate to each other.

In present embodiment 1, explanations will be given on an assumption that a printing job output from the information terminal device 20 (referred to as job data hereinafter) includes multifunction printer designation, which is information designating the multifunction printer 30 that reads a two dimensional code printed by the printing apparatus 10.

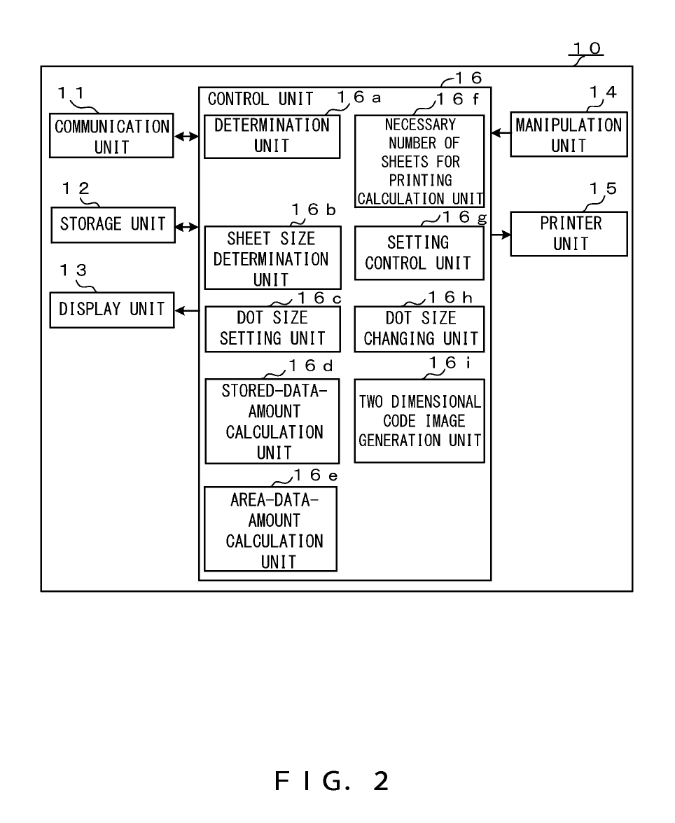

FIG. 2 is a functional block diagram showing a configuration example of the printing apparatus 10, which is a constituent of the printing system 100, in present embodiment 1. The printing apparatus 10 is for example a device that generates a two dimensional code image and prints and outputs the image on a printing medium such as a print sheet or the like in accordance with for example job data output from the information terminal device 20, and includes a communication unit 11, a storage unit 12, a display unit 13, a manipulation unit 14, a printer unit 15 and a control unit 16 as shown in FIG. 2.

The communication unit 11 includes a communication module etc., and performs communications with the information terminal device 20 via network NW. For example, the communication unit 11 receives job data output from the information terminal device 20.

The storage unit 12 includes memory devices such as a Random Access Memory (RAM), a Read Only Memory (ROM), a non-volatile memory, etc., and functions as a program area that stores various types of programs or the like such as an operation program for performing the entire control of the printing apparatus 10 and as a data area that stores various types of data such as sheet property information table T1, multifunction printer information management table T2, which will be described later, and other types of data.

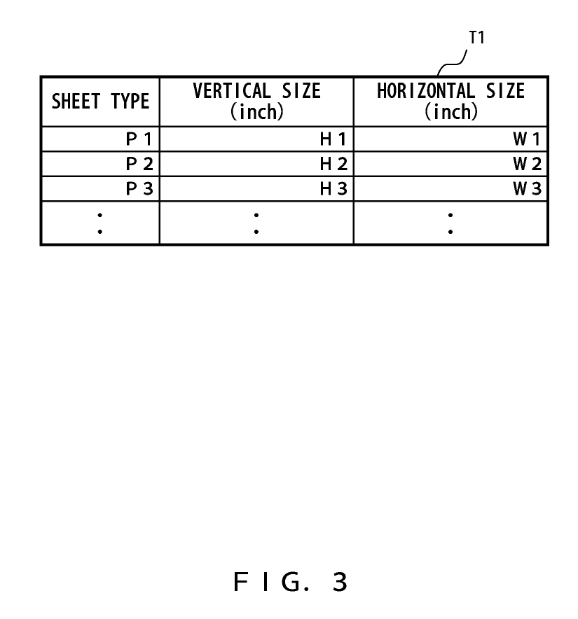

Herein, an explanation will be given for sheet property information table T1 stored in the data area of the storage unit 12 by referring to FIG. 3. FIG. 3 shows an example of sheet property information table T1 according to present embodiment 1.

Sheet property information table T1 is a table that is referred to when for example a sheet size determination unit 16b, which will be described later in detail, determines the size of a print sheet in a two dimensional code image generation process, which will be explained later in detail, and is a table that associates “horizontal size (inch)” and “vertical size (inch)” for each “sheet type” as shown in FIG. 3.

In the column of “sheet type”, types of print sheets that can be treated by the printing apparatus 10 are stored. Examples of types of sheets are A4, A3, etc. In the column of “vertical size (inch)”, sizes in the longitudinal directions of print sheets of corresponding types of sheet are stored, and in the column of “horizontal size (inch)”, sizes in the lateral directions are stored.

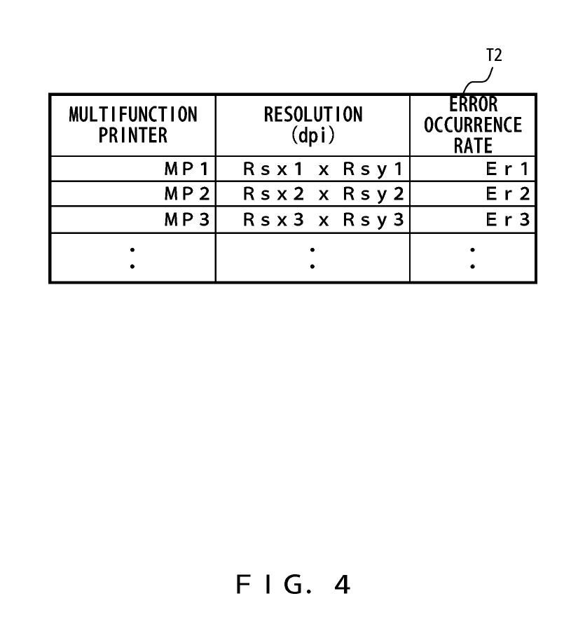

Next, by referring to FIG. 4, explanations will be given for multifunction printer information management table T2 stored in the data area of the storage unit 12. FIG. 4 shows an example of multifunction printer information management table T2 according to present embodiment 1.

Multifunction printer information management table T2 is a table that is referred to when for example a dot size setting unit 16c, which will be described later in detail, performs initial setting of dot size for recording one-bit data in a two dimensional code in a two dimensional code image generation process, and is a table that associates “resolution (dots per inch: dpi)” and “error occurrence rate” for each “multifunction printer” as shown in FIG. 4.

In the column of “multifunction printer”, identification information is stored that can uniquely identify the multifunction printer 30 (for example a device ID). In the column of “resolution (dpi)”, the resolution (dpi) of reading units 31 of the corresponding multifunction printers 30 is stored. For example, in FIG. 4, Rsx1×Rsy1 represents that the resolution in the main scanning directions is Rsx1 (dpi) and the resolution in the sub scanning directions is Rsy1 (dpi).

The column of “error occurrence rate” stores error occurrence rates for the dot size as the initial value in corresponding multifunction printers 30. This error occurrence rate is obtained by for example using the same test pattern for each of the multifunction printers 30.

The explanations return to FIG. 2. The display unit 13 includes a display device such as a Liquid Crystal Display (LCD), an organic Electro-Luminescence (EL), etc., and displays for example various function buttons on the display screen.

The manipulation unit 14 includes ten keys, a touch panel or the like displayed on the display screen of the display unit 13. Users are allowed to execute desired processes by manipulating the manipulation unit 14 so as to input instructions to the printing apparatus 10.

The printer unit 15 includes a printer engine etc., and executes a layout process for each page, executes an imaging process such as for example calibration etc. on page data that received a layout process, and prints and outputs the data on a printing medium such as a print sheet when an RIP process unit (not shown) has generated raster data. For example, the printer unit 15 prints and outputs a two dimensional code image generated by a two dimensional code image generation unit 16i (which will be described later in detail) on a print sheet.

The control unit 16 includes a CPU etc., and executes an operation program stored in a program area of the storage unit 12 so as to realize the functions as a determination unit 16a, the sheet size determination unit 16b, the dot size setting unit 16c, a stored-data-amount calculation unit 16d, an area-data-amount calculation unit 16e, a necessary number of sheets for printing calculation unit 16f, a setting control unit 16g, a dot size changing unit 16h and a two dimensional code image generation unit 16i as shown in FIG. 2, and also executes a process such as a control process of entirely controlling the printing apparatus 10, a two dimensional code image generation process and the like.

The determination unit 16a determines whether or not job data has been received. Also, the determination unit 16a determines whether or not the number of print sheets calculated by the necessary number of sheets for printing calculation unit 16f as the number of print sheets necessary for printing a two dimensional code (referred to as a necessary number of sheets for printing, hereinafter) has increased.

The sheet size determination unit 16b refers to sheet property information table T1 and determines the size of a print sheet used for the printing. More specifically, the sheet size determination unit 16b analyzes job data and determines the type of a print sheet on the basis of information included in the job data for determining the type of a print sheet used for the printing. Also, the sheet size determination unit 16b searches the column of “sheet type” in sheet property information table T1 and determines the “vertical size” and the “horizontal size” that correspond to the determined type of a print sheet.

The dot size setting unit 16c performs initial setting of a dot size of a two dimensional code for recording one-bit data, on the basis of the resolution (dpi) of the reading unit 31 of the multifunction printer 30 that reads a two dimensional code as a printing target and the resolution (dpi) of the printing apparatus 10 of the dot size setting unit 16c. Hereinafter, explanations will be given on an assumption that the dot size in the main scanning directions is Dx (pixels) and the dot size in the sub scanning directions is Dy (pixels).

More specifically, the dot size setting unit 16c analyzes job data, and determines the multifunction printer 30 that reads a two dimensional code as a printing target (referred to as a used multifunction printer 30, hereinafter) on the basis of the multifunction printer designation included in the job data. Then, the dot size setting unit 16c searches the “multifunction printer” column in multifunction printer information management table T2 to determine the “resolution (dpi)” corresponding to the determined multifunction printer 30 and also obtains information of the resolution (dpi) of the printing apparatus 10 of the dot size setting unit 16c. Then, the dot size setting unit 16c calculates the initial value of the dot size in accordance with expression 1 below, where k is a constant set beforehand.

(initial value of Dx(or Dy))=k×(resolution of the printing apparatus 10 in main scanning directions (or sub scanning directions)/(resolution of the reading unit 31 of the used multifunction printer 30 in the main scanning direction (or sub scanning direction))

In other words, the dot size setting unit 16c performs initial setting in which the size of k times the minimum dot size that can be read by the reading unit 31 of the used multifunction printer 30 is the dot size of a two dimensional code for recording one-bit data.

The stored-data-amount calculation unit 16d obtains the sum of the size (bit) of the job data and the size (bit) of data of an error correction code to be added so as to calculate the obtained value as the amount of data to be stored in a two dimensional code (referred to as a stored data amount, hereinafter). An error correction code to be used is for example a Reed-Solomon code or a hamming code, etc., and the correction rate (correction level) of an error correction code is set as the initial setting beforehand.

For example, it is assumed that an error correction code to be used is a Reed-Solomon code, and the initial value of the correction rate is 10%. In the case of a Reed-Solomon code, codes twice the data of the correction target is required, and Se/2(Sj+Se)=0.1 is satisfied where Sj represents the size of job data and Se represents the size of data of the error correction code. Accordingly, Se=Sj/4 is satisfied. In other words, when the size of the job data is 2000 bytes, the size of data of the error correction code is 500 bytes, and in such a case, the stored-data-amount calculation unit 16d calculates 2500 bytes as the stored data amount.

The area-data-amount calculation unit 16e calculates the data amount that can be recorded in the data area, which is an area that can record data in a print sheet.

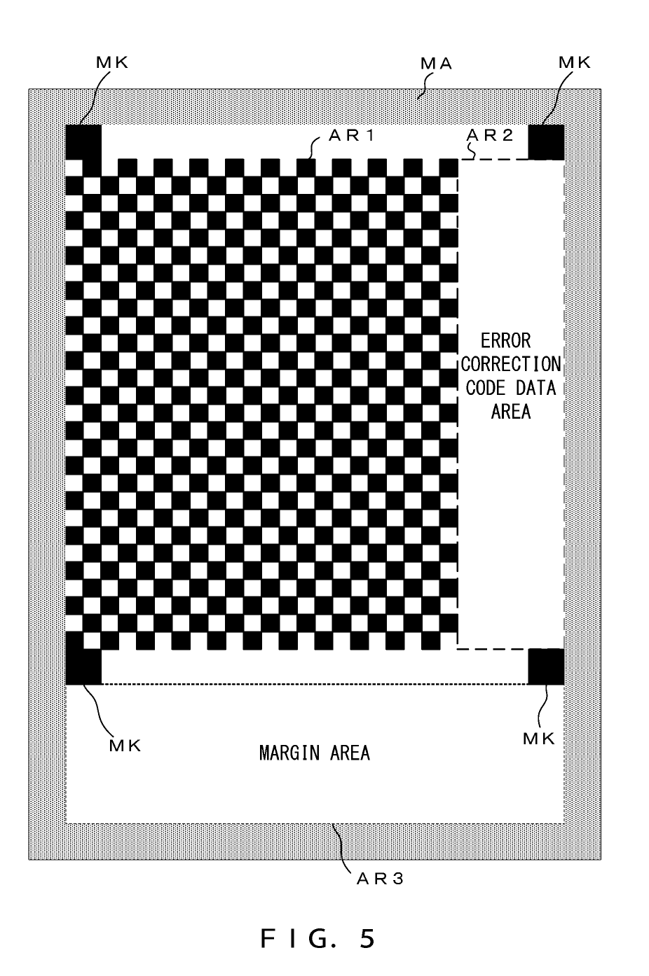

Explanations will now be given for a data area by using the example shown in FIG. 5. FIG. 5 shows an example of a two dimensional code printed on a print sheet according to present embodiment 1. In the example shown in FIG. 5, the data area is the area including original data area AR1, which stores job data, error correction code data area AR2, which stores data of an error correction code, and margin area AR3, which is an area other than the area having the image of the two dimensional code printed thereon in an area that allows printing (printable area). Note that in the example shown in FIG. 5, there are margins between positioning markers MK and data may be stored in these portions as well.

When the size in the main scanning directions of the data area in a designated print sheet is for example Px (inch), the size in the sub scanning directions is Py (inch), the resolution in the main scanning direction of the printing apparatus 10 is Rpx (dpi) and the resolution in the sub scanning directions is Rpy (dpi), the area-data-amount calculation unit 16e calculates the data amount that can be recorded in the data area in accordance with expression 2 below, where “·” represents multiplication.

(data amount that can be recorded in data area)=(number of pixels that can be recorded in the main scanning directions)×(the number of pixels that can be recorded in the sub scanning directions)/{(dot size in main scanning directions)×(dot size in sub scanning directions)}=(Px·Rpx)·(Py·Rpy)/(Dx·Dy)

Because a data area usually corresponds to an area made of combined rectangular areas, the data amount that can be recorded in the data area can be calculated as the sum of the amounts of data that can be recorded in each rectangular area in accordance with expression 2 above. Also, the size of the area of each rectangle may be obtained on the basis of coordinate information of positioning markers MK, information of the size of print sheets, information of printing margins, etc.

The necessary number of sheets for printing calculation unit 16f calculates the necessary number of sheets for printing a two dimensional code in accordance with expression 3 below, where roundup is a function that rounds up values to integers, an example of which is roundup(3.1)=4.

(necessary number of sheets for printing two dimensional code)=roundup{(stored data amount)/(data amount that can be recorded in data area)}

When for example it is assumed that the stored data amount is 13500 bytes and the data amount that can be recorded in the data area is 5200 bytes, the necessary number of sheets for printing a two dimensional code is three.

The setting control unit 16g executes a size reduction process, which will be described later in detail, by cooperating with the area-data-amount calculation unit 16e etc., and executes a process of changing a print sheet to be used to a print sheet of a smaller size when margin area AR3 is sufficiently large.

More specifically, the setting control unit 16g searches the “multifunction printer” column in multifunction printer information management table T2 and determines the “error occurrence rate” corresponding to the used multifunction printer 30. Then, the setting control unit 16g corrects the dot size on the basis of function F1(X), which represents the relationship between an error occurrence rate and a dot size adjustment value, stored in the data area of the storage unit 12. Specifically, the setting control unit 16g obtains the dot size adjustment value corresponding to the determined error occurrence rate, in accordance with function F1(X), and integrates the obtained dot size adjustment value and the initial value of the dot size so as to adjust the dot size.

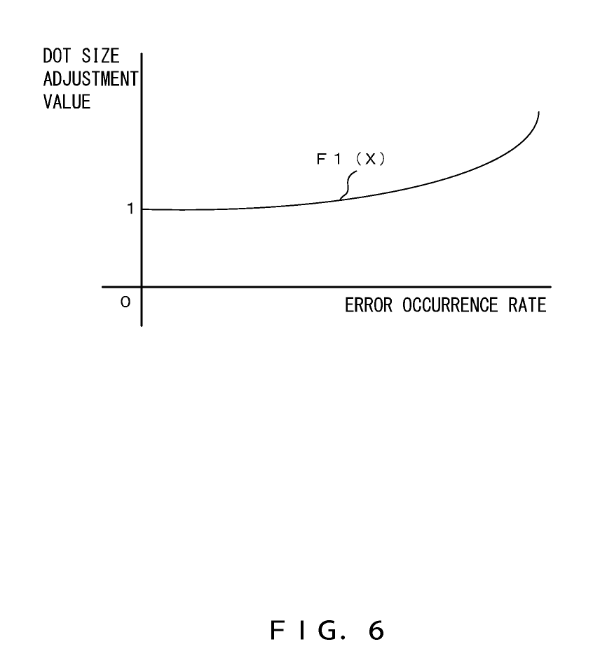

FIG. 6 shows an example of a graph of function F1(X), representing the relationship between an error occurrence rate and a dot size adjustment value according to present embodiment 1. A dot size adjustment value is a value obtained by dividing the minimum dot size whose corresponding error occurrence rate is equal to or smaller than a prescribed value by the initial value of the dot size. Accordingly, the error occurrence rate of the dot size adjusted by integrating the initial value of the dot size and the dot size adjustment value is equal to or smaller than a prescribed value. Function F1(X) can be obtained by using for example a least-square approach.

Then, the area-data-amount calculation unit 16e calculates the data amount that can be recorded in the data area, on the basis of the dot size after being adjusted. Then, the necessary number of sheets for printing calculation unit 16f calculates the necessary number of sheets for printing a two dimensional code in accordance with expression 3 above.

When for example it is assumed that the stored data amount is 13500 bytes and the data amount calculated on the basis of the dot size after being adjusted as a data amount that can be recorded in the data area is 4700 bytes, the necessary number of sheets for printing a two dimensional code is three.

When the necessary number of sheets for printing calculated by the necessary number of sheets for printing calculation unit 16f has not increased from the number before the adjustment of the dot size, the area-data-amount calculation unit 16e calculates the data amount that can be recorded in the data area in a print sheet that is one size smaller on the basis of the dot size after being adjusted.

Then, the necessary number of sheets for printing calculation unit 16f calculates, on the basis of expression 3 above, the necessary number of sheets for printing in a case where a print sheet that is one size smaller is used for printing a two dimensional code. When the calculated necessary number of sheets for printing has not increased from the number before reducing the size, the necessary number of sheets for printing calculation unit 16f again reduces the size of a print sheet and performs the above process. Then, within the scope of sizes that do not lead to an increase in the necessary number of sheets for printing, the setting control unit 16g sets a print sheet of the minimum size as a print sheet to be used.

In FIG. 2 again, the dot size changing unit 16h changes the dot size in such a manner that the stored data amount is substantially equal to the product of the necessary number of sheets for printing a two dimensional code with the dot size as the initial value and the data amount that can be recorded in the data area in the print sheet set by the setting control unit 16g. In other words, the dot size is increased so that margin area AR3 will be eliminated.

On the basis of job data, the two dimensional code image generation unit 16i generates an image of a two dimensional code of the dot size that has been changed by the dot size changing unit 16h. In such a case, the two dimensional code image generation unit 16i also embeds information about the type of a used error correction code as part of the code.

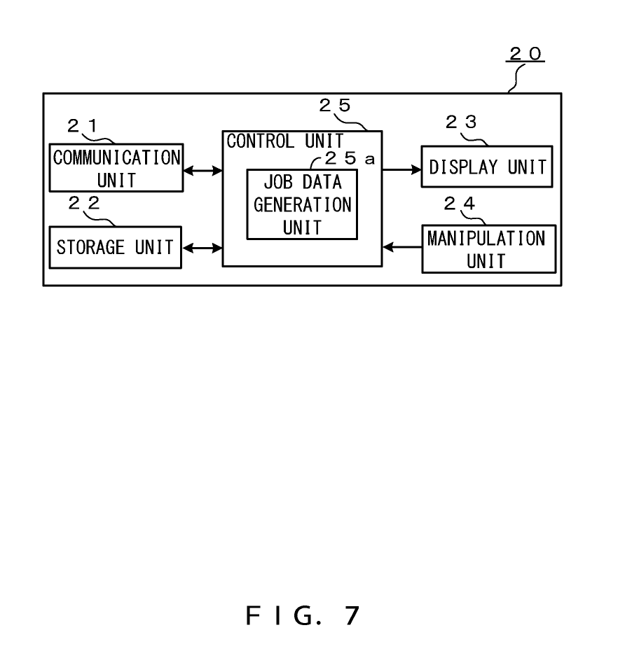

Next, by referring to FIG. 7, explanations will be given for the information terminal device 20 in present embodiment 1. FIG. 7 is a functional block diagram showing a configuration example of the information terminal device 20, which is a constituent of the printing system 100, in present embodiment 1. The information terminal device 20 is a device that generates and outputs job data for for example making the printing apparatus 10 print desired data, and includes a communication unit 21, a storage unit 22, a display unit 23, a manipulation unit 24 and a control unit 25 as shown in FIG. 7.

The communication unit 21 includes a communication module etc., and performs communications with the printing apparatus 10 via network NW. For example, the communication unit 21 transmits, to the printing apparatus 10, job data generated by a job data generation unit 25a, which will be explained later.

The storage unit 22 includes memory devices such as a RAM, a ROM, a non-volatile memory, etc., and functions as a work area of the CPU constituting the control unit 25, a program area that stores various types of programs such as an operation program or the like for performing the entire control of the information terminal device 20 and a data area that stores various types of data such as document data.

The display unit 23 includes a display device such as an LCD, an organic EL display, etc., and displays for example images etc. on the display screen.

The manipulation unit 24 includes for example a keyboard, a touch panel displayed on the display screen of the display unit 23, etc., allows a user to manipulate the manipulation unit 24 to input an instruction to the information terminal device 20 so that desired processes are executed.

The control unit 25 includes a CPU etc., and executes an operation program stored in a program area of the storage unit 22 so as to implement the function as the job data generation unit 25a as shown in FIG. 7, and executes processes such as a control process of performing entire control of the information terminal device 20.

When a user of the information terminal device 20 has made an printing instruction to the printing apparatus 10 by manipulating the manipulation unit 24, the job data generation unit 25a generates job data (printing job) including a parameter regarding various types of printing setting such as the type of print sheet, multifunction printer designation, etc., and printing data, and thereafter transmits the generated job data to the printing apparatus 10 specified by an output destination via the communication unit 21.

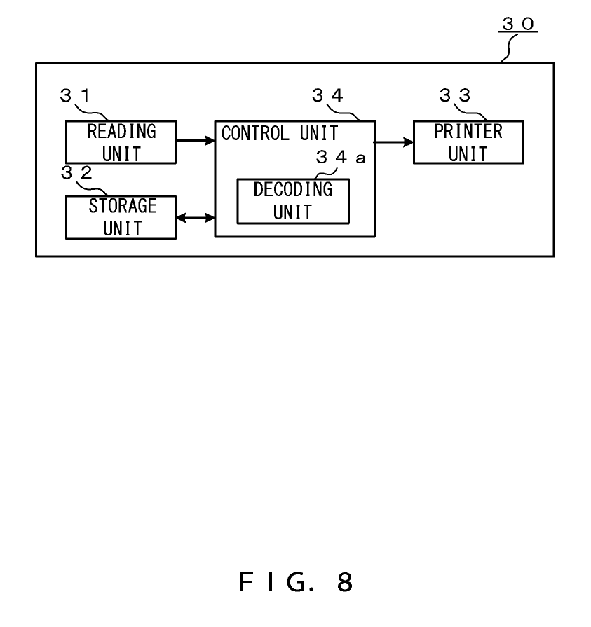

Next, explanations will be given for the multifunction printer 30 according to present embodiment 1 by referring to FIG. 8. FIG. 8 is a functional block diagram showing a configuration example of the multifunction printer 30, which is a constituent of the printing system 100, according to present embodiment 1.

The multifunction printer 30 reads a two dimensional code printed by the printing apparatus 10 on for example a print sheet, decodes the job data as a printing target, and performs a printing process on the decoded job data. As shown in FIG. 8, the multifunction printer 30 includes the reading unit 31, a storage unit 32, a printer unit 33 and a control unit 34.

The reading unit 31 includes a scanner etc., and reads for example a two dimensional code printed by the printing apparatus 10 on a print sheet.

The storage unit 32 includes memory devices such as a RAM, a ROM, a non-volatile memory, etc., and functions as a work area of the CPU constituting a control unit 34, a program area that stores various types of programs such as an operation program or the like for performing the entire control of the multifunction printer 30 and a data area that stores various types of data.

The printer unit 33 includes a printer engine etc., and executes a layout process for each page, executes an imaging process such as for example calibration etc. on page data that has received a layout process, and prints and outputs the data on a printing medium such as a print sheet when an RIP process unit (not shown) has generated raster data. For example, the printer unit 33 performs a printing process on the job data decoded by a decoding unit 34a, which will be described later. More specifically, the printer unit 33 prints and outputs print data on a print sheet in accordance with various types of parameters included in the job data.

The control unit 34 includes a CPU etc., and executes an operation program stored in a program area of the storage unit 32 so as to implement the function as the decoding unit 34a as shown in FIG. 8, and executes processes such as a control process of performing entire control of the multifunction printer 30.

The decoding unit 34a decodes job data from the two dimensional code read by the reading unit 31.

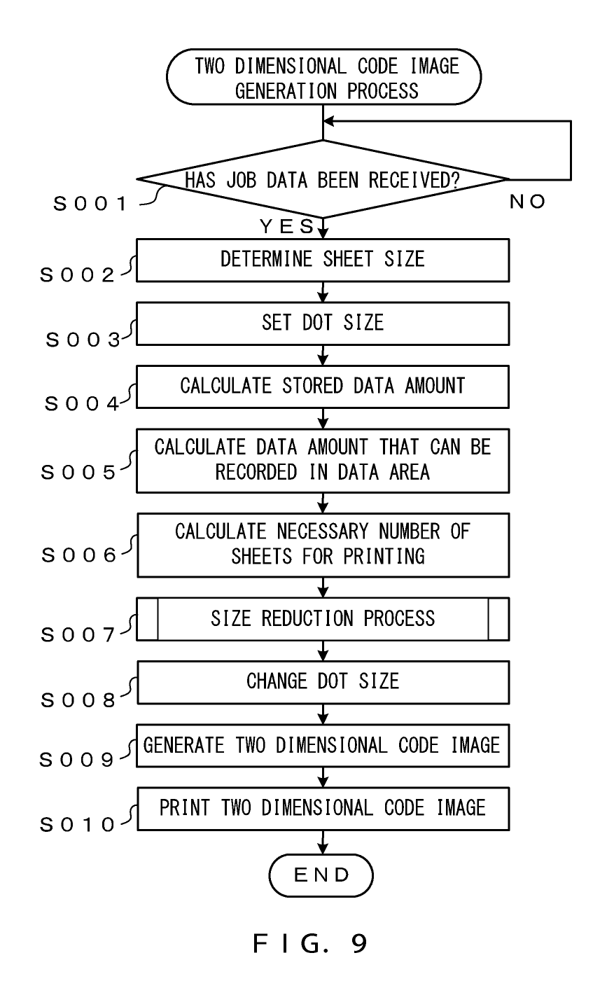

Next, a two dimensional code image generation process according to present embodiment 1 will be explained by referring to FIG. 9. FIG. 9 shows an example of a flowchart for explaining a flow of a two dimensional code image generation process according to present embodiment 1. This two dimensional code image generation process is executed by the printing apparatus 10 and is triggered by the reception of job data output from the information terminal device 20.

The determination unit 16a determines whether or not job data has been received (step S001). When it is determined that job data has not been received (No in step S001), the process repeats the process of step S001 and waits for the reception of job data.

When it is determined by the determination unit 16a that job data has been received (Yes in step S001), the sheet size determination unit 16b refers to sheet property information table T1 and determines the size of a print sheet used for printing (step S002).

The dot size setting unit 16c performs initial setting of a dot size of a two dimensional code for recording one-bit data, on the basis of the resolution (dpi) of the reading unit 31 of the multifunction printer 30 that reads a two dimensional code as a printing target and the resolution (dpi) of the printing apparatus 10 of the dot size setting unit 16c (step S003).

The stored-data-amount calculation unit 16d obtains the sum of the size (bit) of the job data and the size (bit) of data of an error correction code to be added, and calculates the obtained value as the stored data amount (step S004).

The area-data-amount calculation unit 16e calculates the data amount that can be recorded in the data area, on the basis of the dot size as the initial vale and expression 2 above (step S005). Then, the necessary number of sheets for printing calculation unit 16f calculates the necessary number of sheets for printing a two dimensional code on the basis of the stored data amount calculated in the process of step S004 and the data amount calculated in the process of step S005 (step S006).

The setting control unit 16g executes a size reduction process by cooperating with the area-data-amount calculation unit 16e etc., and executes a process of changing a print sheet to be used to a print sheet of a smaller size when margin area AR3 is sufficiently large (step S007).

The dot size changing unit 16h changes the dot size in such a manner that the stored data amount is substantially equal to the product of the necessary number of sheets for printing a two dimensional code with the dot size as the initial value calculated in the process of step S006 and the data amount that can be recorded in the data area in the print sheet set by the setting control unit 16g in the process of step S007 (step S008). In other words, the dot size is increased so that margin area AR3 will be eliminated.

On the basis of job data, the two dimensional code image generation unit 16i generates an image of a two dimensional code of the dot size after being changed by the dot size changing unit 16h (step S009). In such a case, the two dimensional code image generation unit 16i embeds information about the type of a used error correction code as part of the code.

The printer unit 15 prints and outputs a two dimensional code image generated by the two dimensional code image generation unit 16i on a print sheet (step S010). Then, the process terminates and waits for the reception of the next job data.

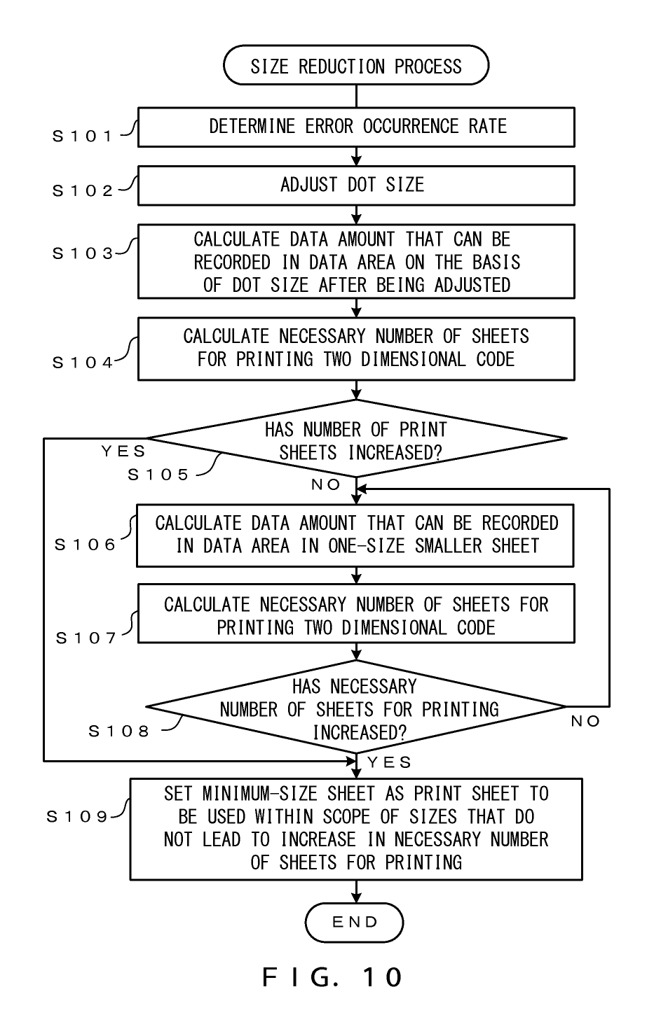

Next, the size reduction process according to present embodiment 1 will be explained by referring to FIG. 10. FIG. 10 shows an example of a flowchart for explaining a flow of the size reduction process according to present embodiment 1. This size reduction process is a process corresponding to the process of step S007 of the above two dimensional code image generation process.

The setting control unit 16g searches the “multifunction printer” column in multifunction printer information management table T2 and determines the “error occurrence rate” corresponding to the used multifunction printer 30 (step S101). Then, the setting control unit 16g adjusts the dot size on the basis of function F1(X), which represents the relationship between an error occurrence rate and a dot size adjustment value, and the determined error occurrence rate (step S102).

The area-data-amount calculation unit 16e calculates the data amount that can be recorded in data area, on the basis of the dot size after being adjusted and expression 2 above (step S103). Then, the necessary number of sheets for printing calculation unit 16f calculates the necessary number of sheets for printing a two dimensional code on the basis of the data amount calculated in the process of step S103 and the stored data amount calculated in the process of step S004 of the two dimensional code image generation process (step S104).

The determination unit 16a determines whether or not the necessary number of sheets for printing calculated by the necessary number of sheets for printing calculation unit 16f in the process of step S104 has increased from the necessary number of sheets for printing calculated in the process of step S006 of the two dimensional code image generation process (step S105). When it is determined by the determination unit 16a that the necessary number of sheets for printing has increased (Yes in step S105), the process proceeds to step S109, which will be explained later.

When it is determined by the determination unit 16a that the necessary number of sheets for printing has not increased (No in step S105), the area-data-amount calculation unit 16e calculates the data amount that can be recorded in the data area in a print sheet that is one size smaller on the basis of the dot size after being adjusted and expression 2 above.

The necessary number of sheets for printing calculation unit 16f calculates, on the basis of the data amount calculated in the process of step S106 and the stored data amount calculated in the process of step S004 of the two dimensional code image generation process, the necessary number of sheets for printing in a case where a print sheet that is one size smaller is used for printing a two dimensional code (step S107).

The determination unit 16a determines whether or not the necessary number of sheets for printing calculated by the necessary number of sheets for printing calculation unit 16f in the process of step S107 has increased from the necessary number of sheets for printing calculated in the process of step S006 of the two dimensional code image generation process (step S108). When it is determined by the determination unit 16a that the necessary number of sheets for printing has not increased (No in step S108), the process returns to step S106 and the above processes are repeated.

When it is determined by the determination unit 16a that the necessary number of sheets for printing has increased (Yes in step S108) or when the determination result in the process of step S105 is Yes, the setting control unit 16g sets a print sheet of the minimum size as a print sheet to be used, within the scope of sizes that do not lead to an increase in the necessary number of sheets for printing.

According to embodiment 1 abovementioned, the printing apparatus 10 generates, on the basis of job data, an image of a two dimensional code so that margin area AR3 will be eliminated. This configuration makes it possible to use the printing surface of a print sheet efficiently.

Also, according to embodiment 1 abovementioned, the printing apparatus 10 updates (increases) the dot size of a two dimensional code so that margin area AR3 will be eliminated. By this configuration, when margin area AR3 exists, margin area AR3 is utilized and the dot size of a two dimensional code is increased and thereby it is possible to suppress the occurrence of reading errors.

Also, according to embodiment 1 abovementioned, the printing apparatus 10 reduces the size of print sheet when it is possible to reduce the size of print sheet without increasing the necessary number of sheets for printing. This configuration makes it possible to utilize resources efficiently.

Also, according to embodiment 1 abovementioned, the printing apparatus 10 reduces the size of print sheet only when the size of print sheet can be reduced without increasing the necessary number of sheets for printing in a case where the dot size has been adjusted (increased) on the basis of an error occurrence rate that results from the multifunction printer 30 reading a two dimensional code of the dot size of the initial setting. This configuration makes it possible to realize both the suppression of occurrence of reading errors and efficient utilization of resources.

### Embodiment 2

According to embodiment 1 abovementioned, when margin area AR3 exits, the dot size is increased so that margin area AR3 will be eliminated and the occurrence of reading errors emerging when the reading unit 31 of the multifunction printer 30 reads a two dimensional code is suppressed. According to present embodiment 2, when margin area AR3 exists, the correction rate of error correction codes (correction level) is increased so as to increase the ability to correct errors so that the occurrence of reading errors is suppressed.

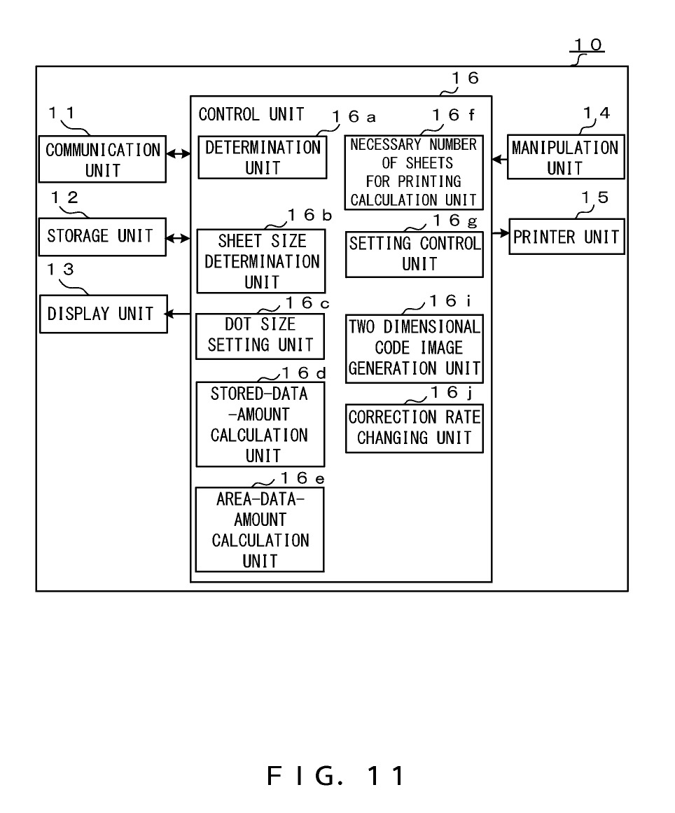

FIG. 11 is a functional block diagram showing a configuration example of the printing apparatus 10 constituting the printing system 100 in present embodiment 2. The printing apparatus 10 according to present embodiment 2 has a fundamental configuration identical to that of the printing apparatus 10 according to embodiment 1.

However, present embodiment 2 is different from embodiment 1 in that the control unit 16 includes a correction rate changing unit 16j instead of the dot size changing unit 16h as shown in FIG. 11. Also, the functions realized by the setting control unit 16g and the two dimensional code image generation unit 16i are different from those in embodiment 1. Also, present embodiment 2 is different from embodiment 1 in that the storage unit 12 stores, in the data area, function F2 (X), which expresses the relationship between an error occurrence rate and a correction rate adjustment value, instead of function F1(X), which expresses the relationship between an error occurrence rate and a dot size adjustment value.

Also, the information terminal device 20 and the multifunction printer 30 according to present embodiment 2 have fundamental configurations that are identical those of the information terminal device 20 and the multifunction printer 30 according to embodiment 1.

The setting control unit 16g executes a size reduction process by cooperating with the area-data-amount calculation unit 16e etc., and executes a process of changing a print sheet to be used to a print sheet of a smaller size when margin area AR3 is sufficiently large.

More specifically, the setting control unit 16g searches the “multifunction printer” column in multifunction printer information management table T2 and determines the “error occurrence rate” corresponding to the used multifunction printer 30. Then, the setting control unit 16g adjusts the correction rate of the error correction code on the basis of function F2 (X), which represents the relationship between an error occurrence rate and a correction rate adjustment value. Specifically, the setting control unit 16g obtains the correction rate adjustment value corresponding to the determined error occurrence rate in accordance with function F2(X), and integrates the obtained correction rate adjustment value and the initial value of the correction rate so as to adjust the correction rate.

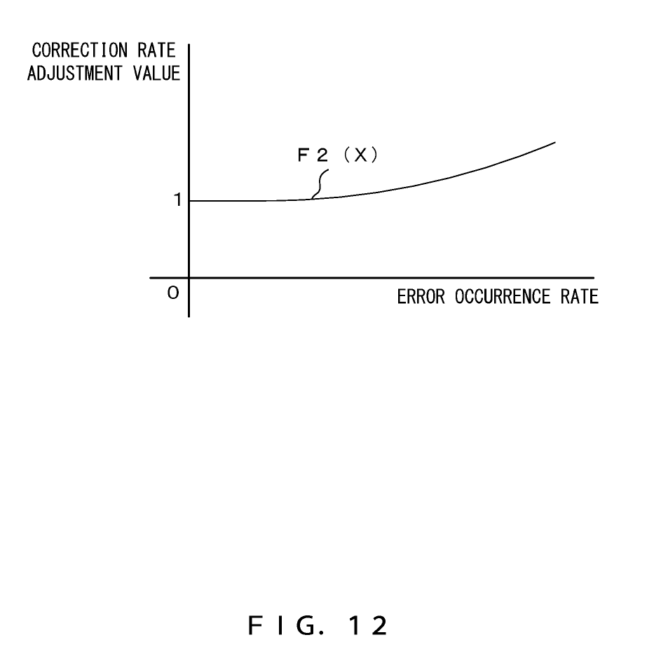

FIG. 12 shows an example of a graph of function F2(X), which represents the relationship between an error occurrence rate and a correction rate adjustment value according to present embodiment 2. A correction rate adjustment value is a value obtained by dividing the minimum correction rate whose corresponding error occurrence rate is equal to or smaller than a prescribed value by the initial value of the correction rate. Accordingly, the error occurrence rate in the correction rate adjusted by integrating the initial value of the correction rate and correction rate adjustment value is equal to or smaller than a prescribed value. Function F2 (X) can be obtained by using for example a least-square approach.

On the basis of the correction rate after being adjusted, the stored-data-amount calculation unit 16d obtains the data size (bit) of an error correction code to be added, and calculates the stored data amount. Then, the necessary number of sheets for printing calculation unit 16f calculates the necessary number of sheets for printing a two dimensional code in a case where a correction rate is adjusted, in accordance with expression 3 above.

When for example it is assumed that the stored data amount after being adjusted is 15200 bytes and the data amount that can be recorded in the data area is 5200 bytes, the necessary number of sheets for printing a two dimensional code is three.

When the necessary number of sheets for printing calculated by the necessary number of sheets for printing calculation unit 16f has not increased from the number in the correction rate before being adjusted, the area-data-amount calculation unit 16e calculates the data amount that can be recorded in the data area in a print sheet that is one size smaller on the basis of expression 2 above.

Then, the necessary number of sheets for printing calculation unit 16f calculates, on the basis of expression 3 above, the necessary number of sheets for printing in a case where a print sheet that is one size smaller is used for printing a two dimensional code. When the calculated necessary number of sheets for printing has not increased from the number before reducing the size, the necessary number of sheets for printing calculation unit 16f again reduces the size of a print sheet and performs the above process. Then, the setting control unit 16g sets a print sheet of the minimum size as a print sheet to be used, within the scope of sizes that do not lead to an increase in the necessary number of sheets for printing.

Again FIG. 11 is explained. On the basis of job data, the two dimensional code image generation unit 16i generates an image of a two dimensional code with the correction rate changed by the correction rate changing unit 16j. In such a case, the two dimensional code image generation unit 16i embeds information about the type of a used error correction code as part of the code.

The correction rate changing unit 16j changes the correction rate in such a manner that the stored data amount is substantially equal to the product of the necessary number of sheets for printing a two dimensional code with the dot size as the initial value and the data amount that can be recorded in the data area in the print sheet set by the setting control unit 16g. In other words, the data size (bit) of the correction code is increased by increasing the correction rate so that margin area AR3 will be eliminated.

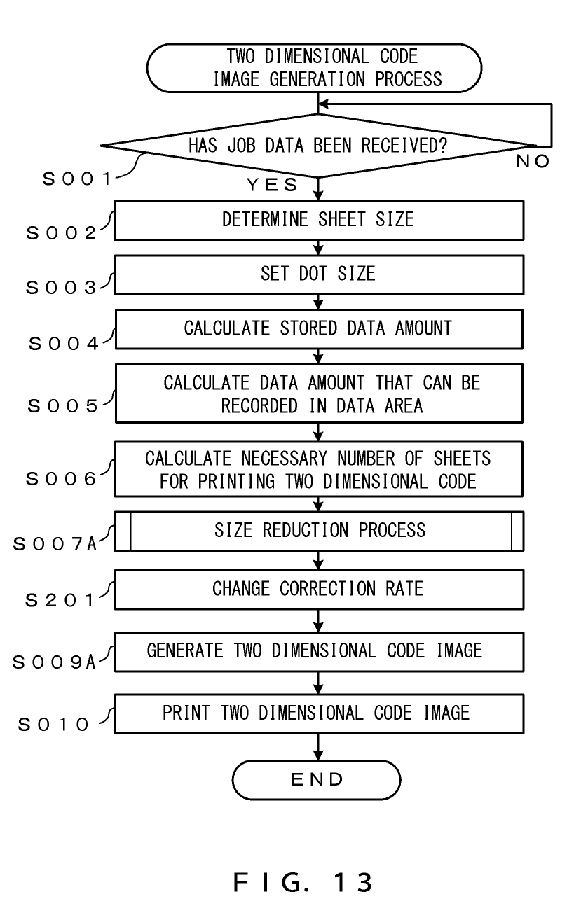

Next, by referring to FIG. 13, explanations will be given for a two dimensional code image generation process according to present embodiment 2. FIG. 13 shows an example of a flowchart for explaining a flow of a two dimensional code image generation process in present embodiment 2. This two dimensional code image generation process is executed by the printing apparatus 10 and triggered by the reception of job data output from the information terminal device 20.

Because the processes up to step S006 in the two dimensional code image generation process according to present embodiment 2 are identical to those in embodiment 1, explanations will be given for the processes in and after step S007A.

The setting control unit 16g executes a size reduction process by cooperating with the area-data-amount calculation unit 16e etc., and executes a process of changing a print sheet to be used to a print sheet of a smaller size when margin area AR3 is sufficiently large.

The correction rate changing unit 16j changes the correction rate in such a manner that the stored data amount is substantially equal to the product of the necessary number of sheets for printing a two dimensional code with the dot size as the initial value calculated in the process of step S006 and the data amount that can be recorded in the data area in the print sheet set by the setting control unit 16g in the process of step S007 (step S201). In other words, the data size (bit) of the error correction code is increased by increasing the correction rate so that margin area AR3 will be eliminated.

On the basis of job data, the two dimensional code image generation unit 16i generates an image of a two dimensional code with the correction rate changed by the correction rate changing unit 16j (step S009A). In such a case, the two dimensional code image generation unit 16i embeds information about the type of a used error correction code as part of the code.

The printer unit 15 prints and outputs a two dimensional code image generated by the two dimensional code image generation unit 16i on a print sheet (step S010). Then, the process terminates and waits for the reception of the next job data.

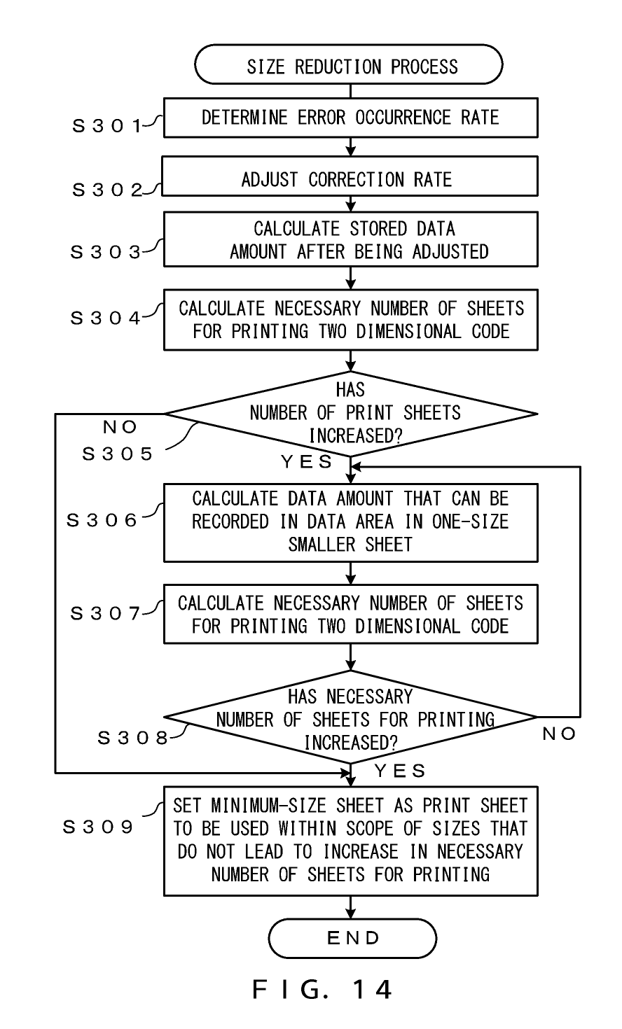

Next, the size reduction process according to present embodiment 2 will be explained by referring to FIG. 14. FIG. 14 shows an example of a flowchart for explaining a flow of the size reduction process according to present embodiment 2. This size reduction process is a process corresponding to the process of step S007A of the above two dimensional code image generation process.

The setting control unit 16g searches the “multifunction printer” column in multifunction printer information management table T2 and determines the “error occurrence rate” corresponding to the used multifunction printer 30 (step S301). Then, the setting control unit 16g adjusts the correction rate of the error correction code on the basis of function F2(X), which expresses the relationship between an error occurrence rate and a correction rate adjustment value (step S302).

On the basis of the correction rate after being adjusted, the stored-data-amount calculation unit 16d obtains the data size (bit) of an error correction code to be added, and calculates the stored data amount (step S303). Then, the necessary number of sheets for printing calculation unit 16f calculates the necessary number of sheets for printing a two dimensional code on the basis of the adjusted stored data amount calculated in the process of step S303 and the data amount calculated in the process of step S005 of the two dimensional code image generation process (step S304).

The determination unit 16a determines whether or not the necessary number of sheets for printing calculated by the necessary number of sheets for printing calculation unit 16f in the process of step S304 has increased from the necessary number of sheets for printing calculated in the process of step S006 of the two dimensional code image generation process (step S305). When it is determined by the determination unit 16a that the necessary number of sheets for printing has increased (Yes in step S305), the process proceeds to step S309, which will be explained later in detail.

When it is determined by the determination unit 16a that the necessary number of sheets for printing has not increased (No in step S305), the area-data-amount calculation unit 16e calculates the data amount that can be recorded in the data area in a print sheet that is one size smaller on the basis of expression 2 above (step S306).

The necessary number of sheets for printing calculation unit 16f calculates, on the basis of adjusted stored data amount calculated in the process of step S303 and the data amount that can be stored in the data area calculated in the process of step S306, the necessary number of sheets for printing in a case where a print sheet that is one size smaller is used for printing a two dimensional code (step S307).

The determination unit 16a determines whether or not the necessary number of sheets for printing calculated by the necessary number of sheets for printing calculation unit 16f in the process of step S307 has increased from the necessary number of sheets for printing calculated in the process of step S006 of the two dimensional code image generation process (step S308). When it is determined by the determination unit 16a that the necessary number of sheets for printing has not increased (No in step S308), the process returns to step S306 and repeats the above processes.

When it is determined by the determination unit 16a that the necessary number of sheets for printing has increased (Yes in step S308) or when the determination result in the process of step S305 is Yes, the setting control unit 16g sets a print sheet of the minimum size as a print sheet to be used, within the scope of sizes that do not lead to an increase in the necessary number of sheets for printing (step S309). Then, the process terminates and the process proceeds to step S201 of the two dimensional code image generation process.

According to embodiment 2 abovementioned, the printing apparatus 10 changes (increases) the correction rate of an error correction code so that margin area AR3 will be eliminated. By this configuration, when margin area AR3 exists, margin area AR3 is utilized and the correction rate of an error correction code is increased and thereby it is possible to increase the ability to correct errors so as to suppress the occurrence of reading errors.

### Embodiment 3

According to embodiment 1 abovementioned, when margin area AR3 exists, the occurrence of reading errors is suppressed by increasing the dot size so that margin area AR3 will be eliminated. Also, according to embodiment 2, when margin area AR3 exits, the correction rate (correction level) of a error correction code is increased so as to increase the ability to correct errors and the occurrence of reading errors is suppressed.

According to present embodiment 3, when margin area AR3 is large, the printing setting such as image quality is changed by for example reducing the printing data size (bit) so that the necessary number of sheets for printing is reduced.

Although the configuration of present embodiment 3 can be applied to both of embodiments 1 and 2 abovementioned, explanations will be given for a case where the configuration of embodiment 3 is applied to the configuration of embodiment 1. Also, explanations will hereinafter be given on an assumption that job data output from the information terminal device 20 includes mode designation, which is information designating a print sheet reduction mode that designates the reduction in the necessary number of sheets for printing when margin area AR3 is large in present embodiment 3.

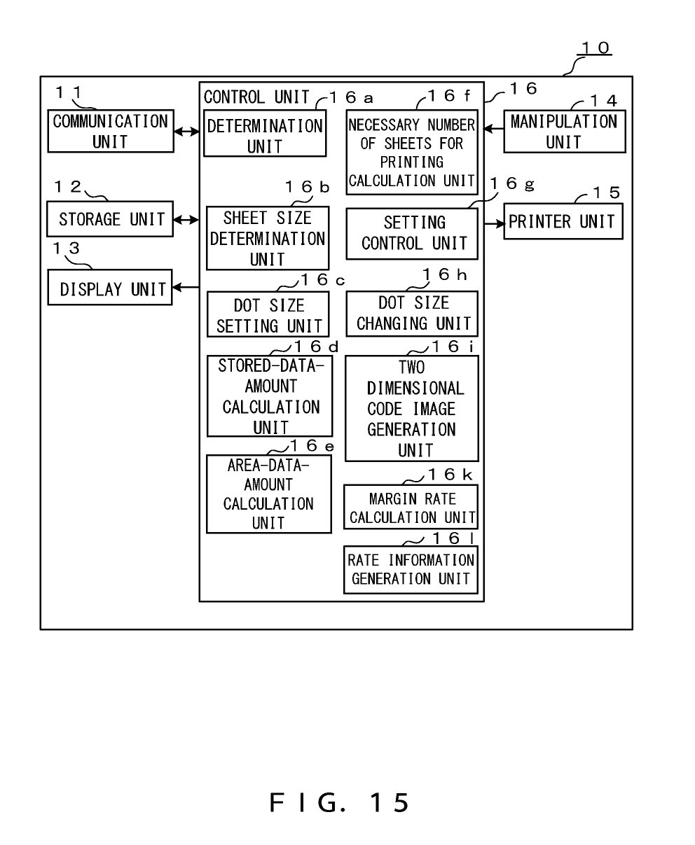

FIG. 15 is a functional block diagram showing a configuration example of the printing apparatus 10, which is a constituent of the printing system 100, according to present embodiment 3. The printing apparatus 10 according to present embodiment 3 has a fundamental configuration identical to that of the printing apparatus 10 according to embodiment 1.

However, present embodiment 3 is different from embodiment 1 in that the control unit 16 further includes a margin rate calculation unit 16k and a rate information generation unit 16l as shown in FIG. 15. Also, the determination unit 16a and the setting control unit 16g have different functions from those in embodiment 1.

The determination unit 16a further determines whether or not received job data includes the designation of a print sheet reduction mode. Also, the determination unit 16a determines whether or not the ratio of margin area AR3 to the data area (referred to as a margin rate hereinafter) calculated by the margin rate calculation unit 16k is equal to or greater than a margin threshold Z (0.8 for example) that is set beforehand.

Also, the determination unit 16a determines whether or not setting changing information D2 or cancellation information D3 transmitted from the information terminal device 20 has been received in response to rate information D1 generated by the rate information generation unit 16l and transmitted to the information terminal device 20. Also, the determination unit 16a further determines whether or not the type of sheet has been changed when setting changing information D2 is received.

When cancellation information D3 is further received, the setting control unit 16g invalidates the changing in printing setting by setting changing information D2 so as to validate the printing setting of job data in a case when setting changing information D2 has already been received. Also, the setting control unit 16g validates the changing in the printing setting of setting changing information D2 when it is possible to reduce the necessary number of sheets for printing under the condition that the changing of the printing setting of setting changing information D2 is met.

The margin rate calculation unit 16k calculates a margin rate when received job data includes the designation of a print sheet reduction mode. More specifically, in accordance with expression 4 below, the margin rate calculation unit 16k obtains the data amount that can be recorded in margin area AR3 and calculates, as a margin rate, the rate of the obtained data amount to the data amount that can be recorded in the data area. Note that rounddown is a function that rounds down values to integers, an example of which is rounddown(3.8)=3.

(data amount that can be recorded in margin area AR3)={(data amount that can be recorded in data area)−(data amount that is to be recorded in last page in stored data amount)}=(data amount that can be recorded in data area)−[(stored data amount)−(data amount that can be recorded in data area)·rounddown{(stored data amount)/(data amount that can be recorded in data area)}]

When for example the stored data amount is 13500 bytes and the data amount that can be recorded in the data area is 5200 bytes, the data amount that can be recorded in margin area AR3 is 5200-{13500-5200×rounddown (13500/5200)}=5200-(13500-5200×2)=2100 bytes. Accordingly, the margin rate is 21/52 in this case.

When the margin rate calculated by the margin rate calculation unit 16k is equal to or greater than margin threshold Z, the rate information generation unit 16l generates rate information D1 including information representing a necessary number of sheets for printing and information representing a margin rate, and outputs generated rate information D1 to the information terminal device 20 that output the job data as process target.

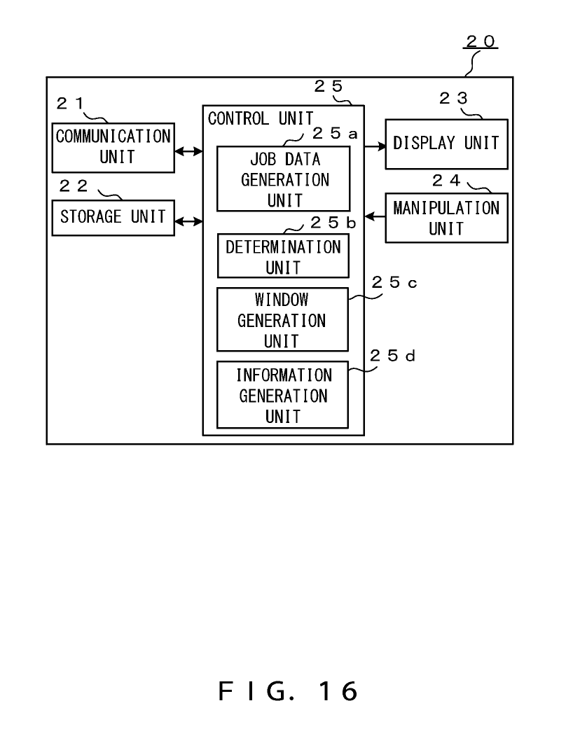

Next, by referring to FIG. 16, explanations will be given for the information terminal device 20 according to present embodiment 3. FIG. 16 is a functional block diagram showing a configuration example of the information terminal device 20, which is a constituent of the printing system 100, according to present embodiment 3.

The information terminal device 20 according to present embodiment 3 has a fundamental configuration identical to that of the information terminal device 20 according to embodiment 1. However, present embodiment 3 is different from embodiment 1 in that the control unit 25 of present embodiment 3 further includes a determination unit 25b, a window generation unit 25c and an information generation unit 25d as shown in FIG. 16.

The control unit 25 includes a CPU etc., and executes an operation program stored in a program area of the storage unit 22 so as to implement the functions as the job data generation unit 25a, the determination unit 25b, the window generation unit 25c and the information generation unit 25d as shown in FIG. 16, and executes processes such as a control process of performing entire control of the information terminal device 20 and a process of a printing setting changing process, etc.

The determination unit 25b determines whether or not rate information D1 transmitted by the printing apparatus 10 has been received. Also, the determination unit 25b determines whether or not the change button provided in the setting changing window, which is generated by the window generation unit 25c and displayed on the display screen of the display unit 23, has been selected. Also, the determination unit 25b determines whether or not the cancel button provided in the setting changing window has been selected.

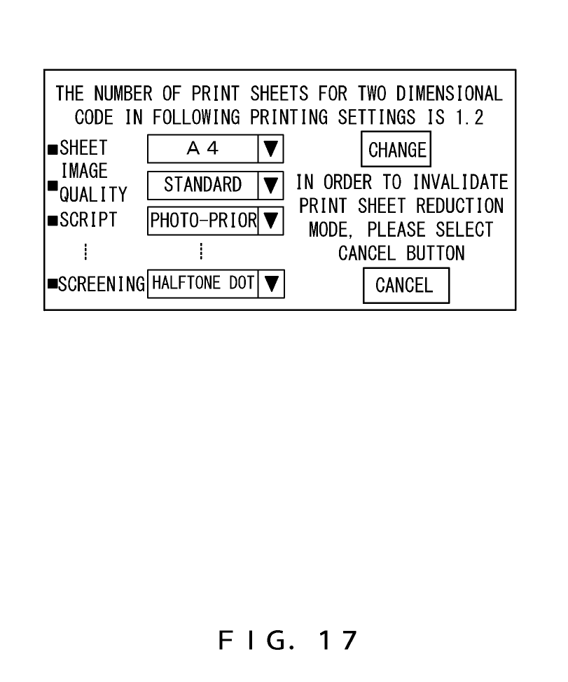

When rate information D1 has been received, the window generation unit 25c generates a setting changing window whose example is shown in FIG. 17 on the basis of information representing a necessary number of sheets for printing and information representing a margin rate, and controls the display unit 23 so as to make the display unit 23 display (in a pop-up manner) the generated setting changing window in the display screen. FIG. 17 shows an example of a setting changing window according to present embodiment 3.

When for example the necessary number of sheets for printing is two and the margin rate is 0.8, the window generation unit 25c determines the number of print sheets to be displayed in the setting changing window as 2−0.8=1.2. As shown in FIG. 17, the setting changing window allows the changing of various types of printing setting such as image quality etc., and when a user selects the change button after changing setting, the information generation unit 25d generates setting changing information D2, which will be described later in detail. Also, as shown in FIG. 17, the setting changing window includes a cancel button for invalidating the print sheet reduction mode, and when a user selects the cancel button, the information generation unit 25d generates cancellation information D3, which will be described later in detail.

FIG. 16 is again explained. When the change button provided in the setting changing window is selected, the information generation unit 25d generates setting changing information D2 representing the content of the changes in the printing setting, or when the cancel button is selected, the information generation unit 25d generates cancellation information D3 representing invalidation of the print sheet reduction mode. Then, the information generation unit 25d returns, via the communication unit 21, generated setting changing information D2 (or cancellation information D3) to the printing apparatus 10 that transmitted rate information D1.

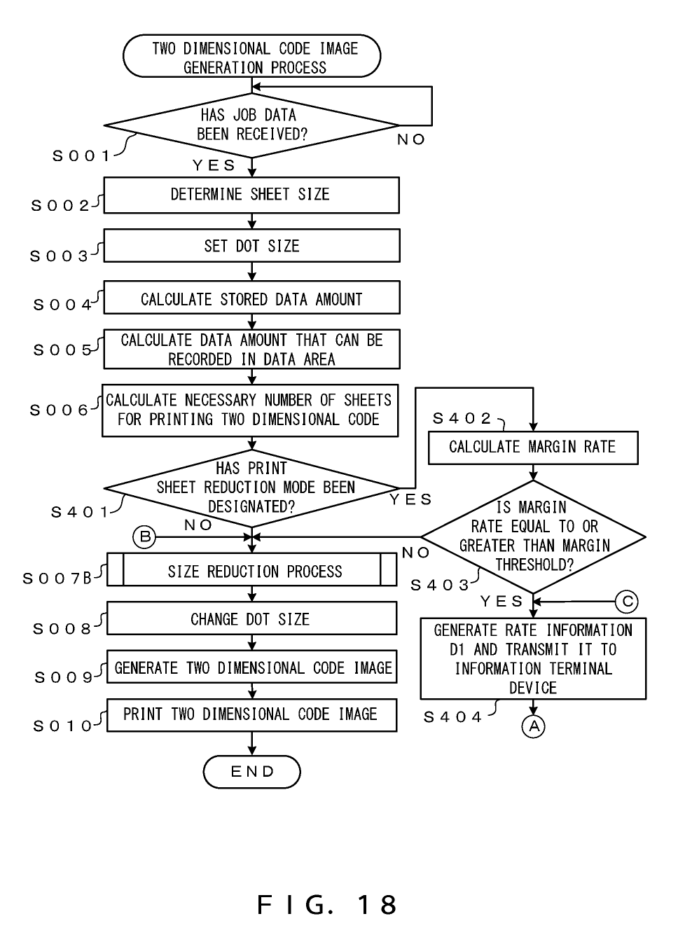

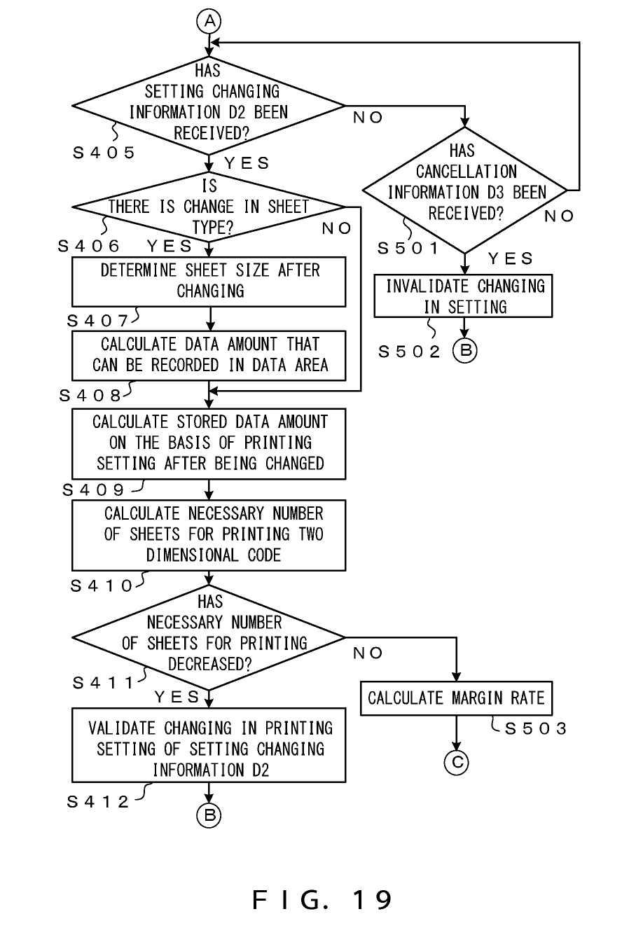

Next, by referring to FIG. 18 and FIG. 19, explanations will be given for a two dimensional code image generation process according to present embodiment 3. FIG. 18 and FIG. 19 show a portion and another portion of a flowchart for explaining the flow of the two dimensional code image generation process according to present embodiment 3. This two dimensional code image generation process is executed by the printing apparatus 10 and triggered by the reception of job data output from the information terminal device 20.

In the two dimensional code image generation process according to present embodiment 3, a determination process is performed by the determination unit 16a between the process of step S006 and the process of step S007B, and when the determination result is Yes, processes specific to present embodiment 3 are executed. Accordingly, explanations will be focused on the processes specific to present embodiment 3.

The necessary number of sheets for printing calculation unit 16f calculates the necessary number of sheets for printing a two dimensional code on the basis of the stored data amount calculated in the process of step S004 and the data amount calculated in the process of step S005 (step S006).

The determination unit 16a determines whether or not received job data includes the designation of a print sheet reduction mode (step S401). When it is determined by the determination unit 16a that the designation of the print sheet reduction mode is not included (No in step S401), the process proceeds to step S007B.

When it is determined by the determination unit 16a that the designation of a print sheet reduction mode is included (Yes in step S401), the margin rate calculation unit 16k calculates a margin rate on the basis of the stored data amount calculated in the process of step S004 and the data amount that can be recorded in the data area calculated in the process of step S005 (step S402).

The determination unit 16a determines whether or not the margin rate calculated by the margin rate calculation unit 16k is equal to or greater than margin threshold Z (step S403). When it is determined by the determination unit 16a that the margin rate is smaller than margin threshold Z (No in step S403), the process proceeds to the step S007B.

When it is determined by the determination unit 16a that the margin rate is equal to or greater than margin threshold Z (Yes in step S403), the rate information generation unit 16l generates rate information D1, and transmits, via the communication unit 11, generated rate information D1 to the information terminal device 20 that output job data as a process target (step S404).

Then, in response to rate information D1 transmitted to the information terminal device 20, the determination unit 16a determines whether or not setting changing information D2 transmitted from the information terminal device 20 has been received (step S405). When it is determined that setting changing information D2 has not been received (No in step S405), the determination unit 16a further determines whether or not cancellation information D3 has been received (step S501).

When it is determined by the determination unit 16a that cancellation information D3 has not been received either (No in step S501), the process returns to step S405, and repeats the above processes. When the determination unit 16a determines that cancellation information D3 has been received (Yes in step S501), the setting control unit 16g invalidates the changing in the printing setting by setting changing information D2 and validates the printing setting of the job data (step S502) in a case where setting changing information D2 has already been received. Then, the process proceeds to step S007B.

In a case where it is determined in step S405 that setting changing information D2 has been received (Yes in step S405), the determination unit 16a further analyzes setting changing information D2 and determines whether or not there is a change in the sheet type (step S406). When it is determined by the determination unit 16a that there are no changes in the sheet type (No in step S406), the process proceeds to step S409, which will be explained later.

When it is determined by the determination unit 16a that there is a change in the sheet type (Yes in step S406), the sheet size determination unit 16b refers to sheet property information table T1 so as to determine the size of a print sheet after being changed (step S407).

Then, the area-data-amount calculation unit 16e calculates the data amount that can be recorded in the data area of the print sheet after being changed, on the basis of the dot size as the initial value and expression 2 above (step S408).

Then, the stored-data-amount calculation unit 16d calculates stored data amount on the basis of the printing setting after being changed (step S409). Then, the necessary number of sheets for printing calculation unit 16f calculates the necessary number of sheets for printing a two dimensional code on the basis of the data amount, calculated in the process of step S408, that can be recorded in the data area of the print sheet after being changed (the data amount calculated in the process of step S005 when the determination result of the process of step S406 is No) and the stored data amount calculated in the process of step S409 (step S410).

Then, the determination unit 16a determines whether or not the necessary number of sheets for printing calculated by the necessary number of sheets for printing calculation unit 16f in the process of step S410 has decreased from the necessary number of sheets for printing calculated in the process of step S006 (step S411).

When it is determined by the determination unit 16a that the necessary number of sheets for printing has decreased (Yes in step S411), the setting control unit 16g validates the changing in the printing setting of setting changing information D2 that reduces the necessary number of sheets for printing (step S412). Then, the process proceeds to step S007B.

When it is determined by the determination unit 16a that the necessary number of sheets for printing has not decreased (No in step S411), the margin rate calculation unit 16k calculates a margin rate on the basis of the data amount, calculated in the process of step S408, that can be recorded in the data area of the print sheet after being changed (the data amount calculated in the process of step S005 when the determine result in process of step S406 is No) and the stored data amount calculated in the process of step S409 (step S503). Then, the process proceeds to step S404 and repeats the above processes.

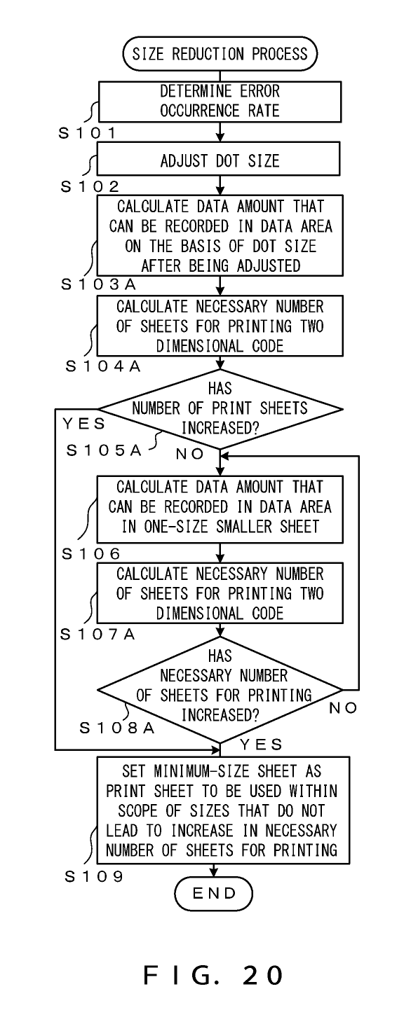

Next, explanations will be given for a size reduction process according to present embodiment 3 by referring to FIG. 20. FIG. 20 shows an example of a flowchart for explaining the flow of the size reduction process according to present embodiment 3. The present size reduction process is a process that corresponds to the process of step S007B of the above two dimensional code image generation process. The size reduction process according to present embodiment 3 is slightly different from the case of embodiment 1.

The setting control unit 16g searches the “multifunction printer” column in multifunction printer information management table T2 and determines the “error occurrence rate” corresponding to the used multifunction printer 30 (step S101). Then, the setting control unit 16g adjusts the dot size on the basis of function F1(X), which expresses the relationship between an error occurrence rate and a dot size adjustment value, and of the determined error occurrence rate (step S102).

Then, area-data-amount calculation unit 16e calculates the data amount that can be recorded in the data area on the basis of the dot size after being adjusted and expression 2 above (step S103A). In this process, when the setting of the sheet type has been changed by the setting control unit 16g, the data amount that can be recorded in the data area in the print sheet after being changed is calculated.

The necessary number of sheets for printing calculation unit 16f calculates the necessary number of sheets for printing a two dimensional code (step S104A) on the basis of the data amount calculated in step S103A and the stored data amount calculated in the process of step S004 of the two dimensional code image generation process (the stored data amount calculated in the process of step S409 when the printing setting has been changed by the setting control unit 16g).

The determination unit 16a determines whether or not the necessary number of sheets for printing calculated by the necessary number of sheets for printing calculation unit 16f in the process of step S104A has increased from the necessary number of sheets for printing calculated in the process of step S006 of the two dimensional code image generation process (the necessary number of sheets for printing after being reduced when the printing setting has been changed by the setting control unit 16g) (step S105A). When it is determined by the determination unit 16a that the necessary number of sheets for printing has increased (Yes in step S105A), the process proceeds to step S109, which will be explained later.

When it is determined by the determination unit 16a that the necessary number of sheets for printing has not increased (No in step S105A), the area-data-amount calculation unit 16e calculates the data amount that can be recorded in the data area in a print sheet that is one size smaller, on the basis of the dot size after being adjusted and expression 2 above (step S106).

Then, the necessary number of sheets for printing calculation unit 16f calculates, on the basis of the data amount calculated in the process of step S106 and the stored data amount calculated in the process of step S004 of the two dimensional code image generation process (the stored data amount calculated in the process of step S409 when the printing setting has been changed by the setting control unit 16g), the necessary number of sheets for printing in a case where a print sheet that is one size smaller is used for printing a two dimensional code (step S107A).

Then, the determination unit 16a determines whether or not the necessary number of sheets for printing calculated by the necessary number of sheets for printing calculation unit 16f in the process of step S107A has increased from the necessary number of sheets for printing calculated in the process of step S006 of the two dimensional code image generation process (the necessary number of sheets for printing after being reduced when the printing setting has been changed by the setting control unit 16g) (step S108A). When it is determined by the determination unit 16a that the necessary number of sheets for printing has not increased (No in step S108A), the process proceeds to step S106 and repeats the above processes.

When it is determined by the determination unit 16a that the necessary number of sheets for printing has increased (Yes in step S108A) or when the determination result in the process of step S105A is Yes, the setting control unit 16g sets a print sheet of the minimum size as a print sheet to be used, within the scope of sizes that do not lead to an increase in the necessary number of sheets for printing (step S109). Then, the process terminates and the process proceeds to step S008 of the two dimensional code image generation process.

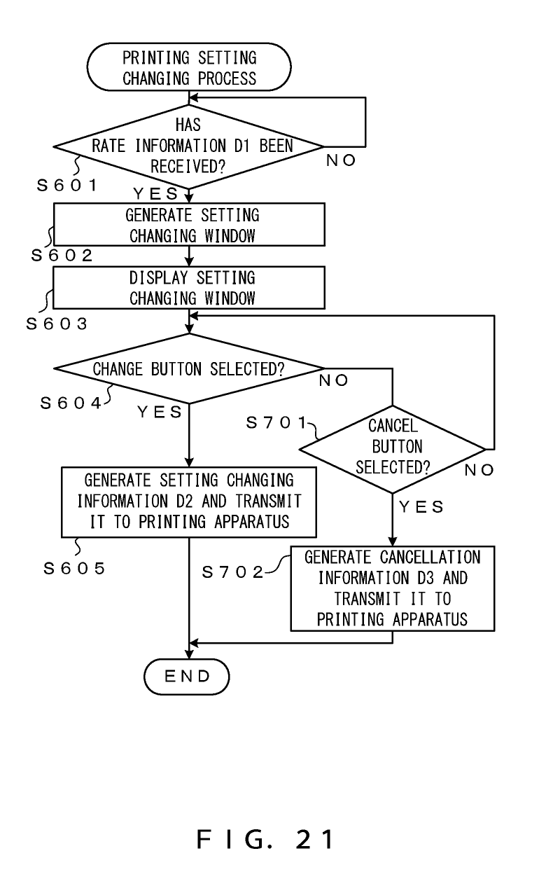

Next, by referring to FIG. 21, explanations will be given for a printing setting changing process according to present embodiment 3. FIG. 21 shows an example of a flowchart that explains a flow of a printing setting changing process according to present embodiment 3. The present printing setting changing process is executed by the information terminal device 20 and triggered by the reception of rate information D1 transmitted from the printing apparatus 10.

The determination unit 25b determines whether or not rate information D1 transmitted from the printing apparatus 10 has been received (step S601). When it is determined by the determination unit 25b that rate information D1 has not been received (No in Step S601), the process repeats the process of step S601 and waits for the reception of rate information D1.

When it is determined by the determination unit 25b that rate information D1 has been received (Yes in step S601), the window generation unit 25c generates a setting changing window on the basis of information representing a necessary number of sheets for printing and information representing a margin rate included in rate information D1 (step S602), and controls the display unit 23 so as to make the display unit 23 display (in a pop-up manner) the generated setting changing window in the display screen (step S603).

The determination unit 25b determines whether or not the change button provided in the setting changing window has been selected (step S604). When it is determined that the change button has not been selected (No in step S604), the determination unit 25b further determines whether or not the cancel button provided in the setting changing window has been selected (step S701).

When it is determined by the determination unit 25b that the cancel button has not been selected either (No in step S701), the process returns to step S604, and repeats the above processes. When the determination unit 25b determines that the cancel button has been selected (Yes in step S701), the information generation unit 25d generates cancellation information D3 representing the invalidation of the print sheet reduction mode and transmits generated cancellation information D3 via the communication unit 21 to the printing apparatus 10 that transmitted rate information D1 (step S702). Then, the process terminates and waits for the reception of the next rate information D1.

When it is determined that the change button has been selected by the determination unit 25b (Yes in step S604), the information generation unit 25d generates setting changing information D2 representing the content of the changes in the printing setting and transmits via the communication unit 21 the generated setting changing information D2 to the printing apparatus 10 that transmitted rate information D1 (step S605). Then, the process terminates and waits for the reception of next rate information D1.

According to embodiment 3 abovementioned, the printing apparatus 10 changes printing setting when margin area AR3 exists and the necessary number of sheets for printing can be reduced by changing the printing setting. This configuration makes it possible to fully utilize the printing surface of a print sheet and to save the labor of reading a two dimensional code.

In the embodiments 1 through 3 abovementioned, explanations were given on an assumption that the image of a two dimensional code is generated by the side of the printing apparatus 10 on the basis of job data output from the information terminal device 20. However, the scope of the present invention is not limited to these embodiments, and it is also possible to employ a configuration in which the side of the information terminal device 20 generates an image of a two dimensional code and the image data of the generated two dimensional code is output to the printing apparatus 10.

Also, in embodiments 1 through 3 abovementioned, explanations were given on an assumption that the multifunction printer 30 is not connected to network NW, however, the scope of the present invention is not limited to this, and the multifunction printer 30 may be connected to network NW.

Also, in embodiments 1 through 3 abovementioned, it is also possible to employ a configuration in which the type of an error correction code that are used and a correction rate are set in accordance with an error occurrence rate of the used multifunction printer 30. In such a case, an error occurrence rate may be obtained from multifunction printer information management table T2. It is also possible to employ a configuration in which a value obtained by adjusting a reference dot size is used as an initial value in accordance with the error occurrence rate of the used multifunction printer 30 operating on the reference dot size.

In embodiments 1 through 3 abovementioned, it is also possible to employ a configuration in which different values are used for constant k in expression 1 between when the dot size in the main scanning directions is set initially and when the dot size in the sub scanning directions is set initially.

Also, in embodiments 1 through 3 abovementioned, it is also possible to employ a configuration in which a two dimensional code that has received a printing process by the multifunction printer 30 is prevented from receiving a printing process even when the two dimensional code is again read by the reading unit 31.

Also, in embodiment 1 abovementioned, explanations were given on an assumption that dot sizes are increased both in the original data portion (original data area AR1) and in the data portion of an error correction code to be added (error correction code data area AR2). However, the scope of the present invention is not limited to this, and it is also possible to increase the dot size in original data area AR1 alone or to increase the dot size in error correction code data area AR2 alone.

Also, in embodiment 1 abovementioned, explanations were given on an assumption that the dot size is increased so that margin area AR3 will be eliminated. However, the scope of the present invention is not limited to this, and it is also possible to employ a configuration for example in which the dot size is increased to the value of a case where the dot size is adjusted on the basis of the dot size adjustment value obtained in the process of step S102 of the size reduction process and the correction rate of the error correction code is increased when margin area AR3 still exists.

Also, in embodiment 2 abovementioned, explanations were given on an assumption that a correction rate is increased so that margin area AR3 will be eliminated. However, the scope of the present invention is not limited to this, and it is also possible to employ a configuration for example in which a correction rate is increased to a value of a case where the correction rate has been adjusted in accordance with the correction rate adjustment value obtained in the process of step S302 of the size reduction process, and the dot size is increased when margin area AR3 still exists.

Also, in present embodiment 2 abovementioned, explanations were given on an assumption that the correction rate of an error correction code is increased so that margin area AR3 will be eliminated. However, the scope of the present invention is not limited to this, and it is also possible to employ a configuration for example in which the type of an error correction code to be used is changed in accordance with the data amount that can be recorded in margin area AR3.

Also, in present embodiment 3 abovementioned, it is also possible to employ a configuration in which the side of the printing apparatus 10 stores printing setting that is often adopted by a user of the information terminal device 20 that output job data as the process target and when the printing setting includes printing setting of reducing a necessary number of sheets for printing, information representing printing setting of reducing a necessary number of sheets for printing is generated so that that information is transmitted to the information terminal device 20 to be selected by the user.

It is also possible to employ a configuration in which an operation program that implements the above operations is stored in a computer-readable recording medium such as a flexible disk, a CD-ROM (Compact Disk-Read Only Memory), a DVD (Digital Versatile Disk), an MO (Magneto Optical disk), etc. and the computer-readable recording medium is distributed so that the operation program is installed in a computer such as the printing apparatus 10 in order to implement the above processes. Further, it is also possible to employ a configuration for example in which an operation program is stored in a disk device or the like included in a server apparatus connected via the Internet and the operation program is delivered to a computer by downloading etc. by superposing the operation program on carrier waves, which transfer information.

Explanations have been given for the embodiments of the present invention. However, the scope of the present invention is not limited to the above embodiments and various configurations or embodiments may be employed without departing from the spirit of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A printing apparatus that generates an image of a two dimensional code and prints the image on the basis of job data in order to cause a different printing apparatus including a reading unit that reads the image of the two dimensional code to execute a printing process, the printing apparatus comprising:
a processor which performs a process including:
setting a dot size for printing the image of the two dimensional code;
changing the dot size to a dot size that can be read at least by the reading unit, by utilizing a margin area, which is an area other than an area on which the image of the two dimensional code has been printed in a printable area in the printing of the image of the two dimensional code;
generating, on the basis of the job data, the image of the two dimensional code based on the dot size after being changed; and
a printer unit that prints, on a print sheet, the image of the two dimensional code generated.

2. A printing apparatus that generates an image of a two dimensional code and prints the image on the basis of job data in order to cause a different printing apparatus including a reading unit that reads the image of the two dimensional code to execute a printing process, the printing apparatus comprising:
a processor which performs a process including:
setting a size of a dot for printing the image of the two dimensional code;
changing a correction rate of an error correction code in the two dimensional code, by utilizing a margin area, which is an area other than an area on which the image of the two dimensional code has been printed in a printable area in the printing of the image of the two dimensional code;
generating, on the basis of the job data, the image of the two dimensional code based on the correction rate after being changed; and
a printer unit that prints, on a print sheet, the image of the two dimensional code generated.
